(19) United States
(12) Patent Application Publication
(10) Pub. No.: US 2023/0228887 A1
(43) Pub. Date: Jul. 20, 2023

(54) Systems, Methods, and Media for Determining a Position of an Aerial System

(71) Applicant: Menet Aero, LLC, Ringwood, IL (US)

(72) Inventors: Michael N. Clark, Melbourne, FL (US); Peter A. Menet, Milwaukee, WI (US); Robert R. Ratcliff, Austin, TX (US)

(21) Appl. No.: 18/095,211

(22) Filed: Jan. 10, 2023

Related U.S. Application Data
(60) Provisional application No. 63/298,007, filed on Jan. 10, 2022.

(51) Int. Cl. G01S 19/45; G01S 19/06

(52) U.S. Cl. CPC G01S 19/45; G01S 19/06

(57) ABSTRACT

In accordance with some embodiments, systems, methods, and media for determining a position of an aerial system are provided. In some embodiments, a method comprises: receiving, from a 3D range sensor, position information indicative of a position of one or more objects in a sensor region during a first time period, wherein the position information comprises a plurality of points, each point of the plurality of points being associated with an altitude, and a 2D lateral position; receiving, from the tethered air system, an altitude value; identifying one or more points of the plurality of points with an altitude corresponding to the altitude value; and determining a current position of the tethered air system based on the 2D lateral position associated with the one or more points.

### CROSS-REFERENCE TO RELATED APPLICATIONS

This application is based on, claims the benefit of, and claims priority to U.S. Provisional Application No. 63/298,007, filed Jan. 10, 2022, which is hereby incorporated herein by reference in its entirety for all purposes.

### STATEMENT REGARDING FEDERALLY SPONSORED RESEARCH

NA

### BACKGROUND

Many copter-type unmanned air systems (UASs) can be configured to hold a position using satellite positioning, such as global position system (GPS). The ability to maintain a given position (e.g., latitude, longitude, and altitude, which are sometimes referred to herein using coordinates X, Y, and Z, respectively) depends on the horizontal dilution of precision (HDOP). The accuracy of the estimated location is generally correlated to satellite constellation geometry and the total number of the satellites the UAS receives signals from. For example, if the UAS receives signals from satellites lined up in a row (e.g., aligned along an arc), then the HDOP is likely to be relatively high, causing the UAS to potentially drift along the X and/or Y position. As another example, if the UAS receives signals from satellites that are spaced more evenly (e.g., in a grid pattern, forming vertices of a polygon, etc.) HDOP is likely to be relatively low. In general, HDOPs of 1.2 or less favor excellent position resolution. Therefore, in some situations, UASs that rely on satellite positioning may experience low positional accuracy and may drift from a particular position. As yet another example, GPS signals may become unreliable in a particular area (e.g., due to active jamming and/or spoofing, and/or via passive mechanisms such as weather, reflected signals, blocked signals, etc.).

Accordingly, new systems, methods, and media for determining a position of an aerial system are desirable.

### SUMMARY

In accordance with some embodiments of the disclosed subject matter, systems, methods, and media for determining a position of an aerial system are provided.

In accordance with some embodiments of the disclosed subject matter, a method for determining a location of a tethered air system is provided, the method comprising: receiving, from a 3D range sensor, position information indicative of a position of one or more objects in a sensor region during a first time period, wherein the position information comprises a plurality of points, each point of the plurality of points being associated with an altitude, and a 2D lateral position; receiving, from the tethered air system, an altitude value; identifying one or more points of the plurality of points with an altitude corresponding to the altitude value; and determining a current position of the tethered air system based on the 2D lateral position associated with the one or more points.

In some embodiments, the 2D lateral position includes a latitude and a longitude.

In some embodiments, the 2D lateral position includes an X position and a Y position in a Cartesian coordinate system.

In some embodiments, the method further comprises: receiving, from the 3D range sensor, subsequent position information indicative of a position of one or more objects in the sensor region during a second time period; determining that the subsequent position information is unreliable; and in response to determining that the subsequent position information is unreliable, causing an alert to be provided.

In some embodiments, the method further comprises: instructing the tethered air system to move to a target location based on the current position.

In some embodiments, the position information comprises point cloud data.

In accordance with some embodiments of the disclosed subject matter, a system for determining a location of a tethered air system is provided, the system comprising: at least one processor that is configured to: receive, from a 3D range sensor, position information indicative of a position of one or more objects in a sensor region during a first time period, wherein the position information comprises a plurality of points, each point of the plurality of points being associated with an altitude, and a 2D lateral position; receive, from the tethered air system, an altitude value; identify one or more points of the plurality of points with an altitude corresponding to the altitude value; and determine a current position of the tethered air system based on the 2D lateral position associated with the one or more points.

In accordance with some embodiments of the disclosed subject matter, a system is provided, the system comprising: an air system comprising: a rotor; a motor coupled to at least one rotor; an altitude sensor; and at least one processor that is configured to: determine an altitude value using the rangefinder; and transmit the altitude value via a communication system; a 3D range sensor comprising: at least one processor that is configured to: detect positions of objects within at least a sensor region; and transmit information indicative of positions of objects within the sensor region; a computing device electrically coupled to the 3D range sensor and the tethered air system, the computing device comprising: at least one processor that is configured to: receive the altitude value; receive the information indicative of positions of objects within the sensor region; filter the information indicative of positions of objects within the sensor region using the altitude value; determine a position of the tethered air system based on the filtered information; and cause the tethered air system to move to a target position based on a difference between the determined position and the target position.

In some embodiments, the altitude sensor comprises a rangefinder.

In some embodiments, the at least one processor is further configured to: transmit the altitude value via a tether coupled to the communication system.

In some embodiments, the communication system comprises a wireless transceiver, and the at least one processor is further configured to: transmit the altitude value via the wireless transceiver.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example of a system for determining a position of an aerial system in accordance with some embodiments of the disclosed subject matter.

FIG. 2 shows an example of hardware that can be used to implement a three-dimensional range sensor, a computing device, an aerial device controller, and an aerial system, shown in FIG. 1 in accordance with some embodiments of the disclosed subject matter.

FIG. 3 shows an example of a flow for determining a position of an aerial system in accordance with some embodiments of the disclosed subject matter.

FIG. 4 shows an example of a process for determining a position of an aerial system in accordance with some embodiments of the disclosed subject matter.

### DETAILED DESCRIPTION

In accordance with various embodiments, mechanisms (which can, for example, include systems, methods, and media) for determining a position of an aerial system are provided.

In some embodiments, aerial unmanned air systems (UASs) can be configured with a tether via which the UAS can be remote controlled and/or powered from the ground. In such embodiments, a tether may facilitate data and/or video to be downloaded from the UAS using a cable (e.g., the same cable used to transfer power). In some embodiments, a tethered UAS can be configured as a copter (e.g., having one or more rotors), that can be configured to maintain a particular position (e.g., a particular latitude, longitude, and altitude).

In some embodiments, a tethered air system (e.g., a tethered UAS) can be operated for extended periods of time and can facilitate more secure communications and/or higher data transfer rates. For example, a tethered UAS can hold a position for hours (e.g., for days) without replacing batteries. As another example, tethered UASs can facilitate relatively fast data exchanges (e.g., using a wired communication technique, using a fiber optic communication technique), where wireless UASs may utilize slower wireless communication techniques (e.g., using radio frequency signals). In a more particular example, many UASs that utilize wireless communications over RF have serial baud of about 57,000 (e.g., about 57 kilobits per second (kbs)), and tethered systems can generally communicate at a rate of at least 115,200 baud (e.g., about 115 kbps), with communications over optical fibers generally being much higher. Faster data transfers can facilitate faster reaction of the UAS to instructions to change position from a controller (e.g., a ground controller). Additionally, the UAS can send data to a controller (and/or other computing device) and/or can receive instructions from a controller (and/or other computing device) in near real-time with little delay in receiving new coordinates and/or instructions to navigate to new coordinates. As yet another example, communications over a tether can be more secure and/or less susceptible to interference (e.g., RF interference).

A UAS's altitude can be measured in several ways. For example, GPS can be used, but the accuracy is limited to tens of meters due to the geometries involved. Accuracy can be improved using real-time kinematic (RTK) techniques that reference two GPS receivers to derive at best a 2-centimeter accurate solution. Adding RTK has shown excellent GPS-based altitude measurements at the cost of adding complexity and hardware to the system. Additionally, GPS techniques produce an altitude relative to the ellipsoidal earth or relative to mean sea level (MSL) defined as the ellipsoidal earth plus the geoid. Pilots generally using an above ground level (AGL) altitude value, which can be derived from the GPS-derived altitude using a formula to convert between the two coordinate systems.

As another example, a UAS can measure the UAS's altitude using air pressure changes using a sensor that is sometimes referred to as a barometer. This sensor is relatively small in size and low cost. Resolution is moderate (e.g., about ±0.5-1 meters) for short periods of time (e.g., minutes to hours, depending on how quickly weather conditions change), and can be considered an AGL value as altitude is based on a reference pressure (e.g., takeoff pressure) that is used as ‘ground zero.’ However, because tethered UASs have relatively long operational times (e.g., days). Ambient barometric pressure can be expected to change significantly during tethered flights. Such atmospheric pressure differences between the start of a flight and the end of a flight can result in an altitude difference of several meters (e.g., 12 to 18 meters). Accordingly, many tethered UASs may use techniques other than (or in addition to) barometers to measure altitude.

In some embodiments, a UAS can be configured with a laser rangefinder to determine the UAS's altitude (e.g., AGL altitude value). For example, a laser range finder can be configured to determine a time-of-flight of a laser beam projected down from the UAS. A laser rangefinder has relatively high accuracy, is relatively light weight, and relatively low cost. A laser rangefinder is not affected by atmospheric pressure changes or satellite positions, can have resolution in centimeters, and can generate an AGL altitude value. For example, currently available low-cost laser rangefinders can measure altitudes at least 100 meters above the ground with a resolution of about one centimeter. In a more particular example, the UAS can be configured to use an SF11/C rangefinder available from Lightware Lidar LLC of Boulder Colo.

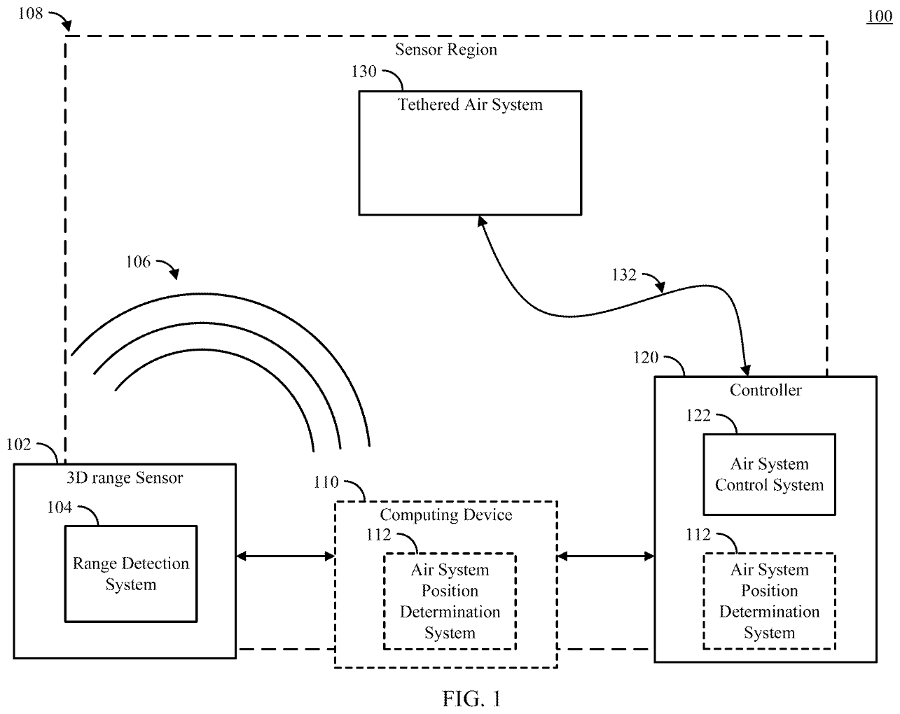

In some embodiments, a UAS can use a laser rangefinder to determine an altitude of the UAS, which can be utilized to maintain a particular altitude when a UAS is configured to navigate and hold a position while in flight. Additionally, in some embodiments, the UAS can utilize GPS (and/or another suitable satellite positioning system) to determine the position of the UAS in the X and/or Y coordinates. However, GPS positioning accuracy may be relatively poor in some locations and/or under some conditions, and/or GPS signals may be intentionally disrupted (e.g., via jamming or spoofing). In such conditions, a UAS may maintain an accurate altitude if the UAS used a non-GPS technique to determine altitude but can be expected to drift in the X and/or Y direction(s) depending on environmental conditions (e.g., due to prevailing wind). When in such a GPS-compromised environment, the UAS may be flown manually to maintain an X and Y position. However, operating without automation is stressful on the pilot and steady position holding is near impossible without sensor-driven techniques, and can lead to pilots choosing to land the UAS and wait for the GPS signal to be more reliable. In some embodiments, mechanisms described herein can enable a pilot to mitigate the stress of manually keeping a position in the absence of a reliable GPS signal via a position determined using a 3D range sensor (e.g., as described below in connection with FIG. 1).

In some embodiments, mechanisms described herein can be used to determine a lateral position of a tethered UAS (e.g., when GPS is compromised), which can facilitate accurate automated positioning. In some embodiments, the UAS can determine an altitude of the UAS (e.g., a true AGL value). As described above, a laser range finder can be used to relatively accurately determine altitude. In some embodiments, a ground sensor or set of ground sensors can be used to assist the UAS in determining a position of the UAS in 3D space. For example, a LiDAR system can be used to determine the location(s) of objects within a particular 3D space. As another example, a millimeter (mm) wave radar system can be used to determine the location(s) of objects within a particular 3D space. As yet another example, a stereoscopic vision system can be used to determine the location(s) of objects within a particular 3D space. As still another example, a structured light system can be used to determine the location(s) of objects within a particular 3D space. As a further example, a time-of-flight 3D camera system (e.g., a continuous wave time-of-flight system, a pulsed time-of-flight system) can be used to determine the location(s) of objects within a particular 3D space.

In some embodiments, mechanisms described herein can use Kalman filtering to tack a position of a UAS based on a combination of data from a UAS's inertial measurement unit (IMU) data (e.g., including acceleration and rotational speeds), and data from a 3D range sensor (e.g., lidar measurement data). For example, a current UAS position and the IMU data can be used to predict a next probable position of the UAS using a Kalman Filter. Such a predicted position can be used to find a cluster of 3D range sensor measurements that are predicted to correspond to the UAS. The 3D range sensor measurements can be used to correct the current position of the UAS. In some embodiments, such techniques can be used to track a position of a UAS from takeoff to landing.

In some embodiments, mechanisms described herein can utilize the estimated altitude (e.g., the AGL value) of the UAS to filter information from a ground-based 3D sensor such that data points in 3D data that do not correspond to the altitude of the UAS can be removed from the data. This can reduce the amount of data to be processed to determine the lateral location of the UAS. In some embodiments, 3D ground sensor(s) can generate millions position points a second. Processing such large amounts of data to segment, identify, and track an object (e.g., a UAS) is computationally expensive, and ground-based processing hardware may not be able to reliably determine the X-Y position of a UAS within a reasonable amount of time. In some embodiments, mechanisms described herein can utilize a ground sensor(s) to scan an upwards, predefined section of sky that is likely to include the tethered UAS, as tethered UASs may be restrained by their tethers, and unable to travel very far laterally.

In some embodiments, mechanisms described herein can utilize a relatively simple query to detect only those points in the 3D position data associated with a predetermined portion of sky that match the altitude of a tethered UAS. In some embodiments, mechanisms described herein can analyze the filtered 3D position data to determine the tethered UAS's corresponding X and Y positions and can provide the position information to the UAS as a GPS replacement position. In general, tethered UAS operations can be expected to be clear of other objects at the altitude reported by the UAS because the ground sensor is limited to a region of sky expected to include the UAS. For example, a bird may fly near the UAS, but usually wouldn't be present long enough to significantly impact the 3D position data. Data points corresponding to the tether can be removed from the 3D position data when filtering using the UAS's altitude, as the tether is below the UAS's reported altitude. In some embodiments, utilizing such filtering techniques (e.g., in addition to, or in lieu of, complex object tracking algorithms, such as Kalman filters), mechanisms described herein can perform a computationally efficient operation utilizing a relatively simple query based on a collaboration of ground sensing and sensing at the UAS.

In some embodiments, mechanisms described herein can be implemented with a commercially available UAS. For example, mechanisms described herein can utilize existing messaging protocols that are defined in the robotic operating system (ROS) (an open source collection of software made available by Open Robotics headquartered in Mountain View, Calif.) and the micro air vehicle link (MAVLink) message specification used by the open source flight control software ArduCopter. In such an example, user datagram protocol (UDP) sockets can be used to transmit ROS and MAVLink messages between a ground controller and the UAS. ROS includes libraries for sensors such as Lidar, Radar, and 3D vision. Additionally or alternatively, in some embodiments, mechanisms described herein can be implemented with a commercially available UAS using an open-source flight controller, such as ArduCopter or PX4 running on a Pixhawk Cube′ that uses MAVLink-based telemetry communication to support command and control (C2), health, and status. In some embodiments, MAVLink can be used within the ROS infrastructure via a ‘MAVROS’ bridge service. In some embodiments, utilizing such software and/or hardware, mechanisms described herein can be configured to switch GPS receiving off and re-direct the UAS to receive position information from another source over a messaging channel described above. In some embodiments, mechanisms described herein can be implemented using a ground station control system that uses MAVLink, which is sometimes referred to herein as DPACS.

FIG. 1 shows an example of a system for determining a position of an aerial system in accordance with some embodiments of the disclosed subject matter. As shown in FIG. 1, a computing device 110 can receive position information from a 3D range sensor 102. In some embodiments, computing device 110 can execute at least a portion of an air system position determination system 112 to estimate a 3D position of a tethered air system 130 (e.g., utilizing position information received from 3D range sensor 102 and tethered air system 130). In some embodiments, computing device 110 can act as a proxy server that receives and/or retrieves information from 3D range sensor 102, and in turn, provides information to controller 120. For example, computing device 110 can subscribe to 3D range sensor 102, and selectively publishes information received from 3D range sensor 102 to controller 120. As another example, 3D range sensor 102 can be configured to broadcast data (e.g., point cloud data) on one or more communication interfaces (e.g., via an Ethernet port), and computing device 110 can be configured to receive such communications.

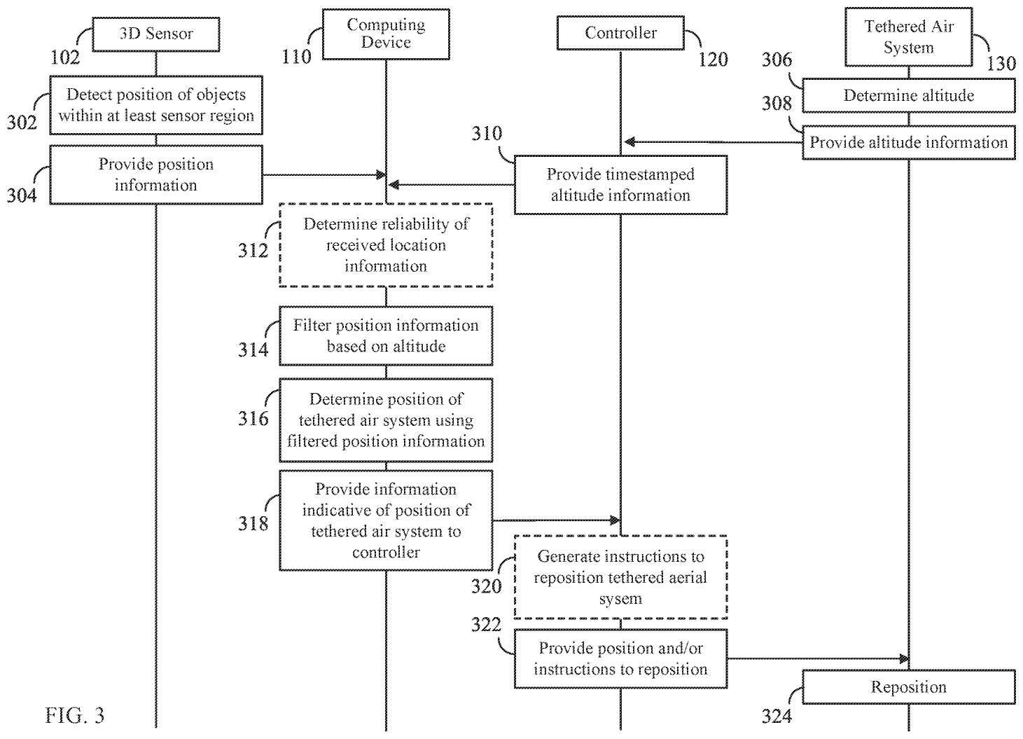

Additionally or alternatively, in some embodiments, computing device 110 can communicate position information received from 3D range sensor 102 to a controller 120 (e.g., over a communication network, which may include wired communication links and/or wireless communication links), which can execute at least a portion of air system position determination system 112. In such embodiments, controller 120 can return information to computing device 110 (and/or any other suitable computing device) indicative of an output of air system position determination system 112 to indicate a current position and/or a set position of tethered air system 130. In some embodiments, air system position determination system 112 can execute one or more portions of flow 300 and/or process 400 described below in connection with FIGS. 3 and/or 4, respectively. In some embodiments, computing device 110 can be omitted (e.g., controller 120 can be configured to receive position data from range sensor 102 and execute air system position determination system 112). Communications links shown in FIG. 1 can each be any suitable communications link or combination of communications links, such as wired links, fiber optic links, Wi-Fi links, Bluetooth links, cellular links, etc.

In some embodiments, computing device 110 and/or controller 120 can be any suitable computing device or combination of devices, such as a desktop computer, a laptop computer, a smartphone, a tablet computer, a wearable computer, a single-board computer (e.g., a Raspberry Pi), a server computer, a virtual machine being executed by a physical computing device, etc.

In some embodiments, 3D range sensor 102 can be any suitable sensor or sensors that can be used to determine the 3D position of one or more objects in a particular region of 3D space. For example, 3D range sensor 102 can be implemented using one or more LiDAR sensors, one or more mm wave radar systems, one or more stereoscopic vision cameras, one or more structured light cameras, one or more time-of-flight 3D cameras, etc.

In some embodiments, 3D range sensor 102 can be local to computing device 110 and/or controller 120. For example, 3D range sensor 102 can be incorporated with computing device 110 (e.g., computing device 110 can be configured as part of a device for capturing and/or storing 3D range data). As another example, 3D range sensor 102 can be connected to computing device 110 and/or controller 120 by a cable, a direct wireless link, etc. Additionally or alternatively, in some embodiments, 3D range sensor 102 can be located locally and/or remotely from computing device 110 and/or controller 120, and can communicate position data to computing device 110 and/or controller 120 via a communication network.

In some embodiments, 3D range sensor 102 can execute at least a portion of a range detection system 104 to generate information indicative of the 3D location of objects within at least a predetermined sensor region 108. For example, 3D range sensor 102 can execute at least a portion of a range detection system 104 to generate point cloud data that includes data points corresponding to objects within sensor region 108. In such an example, each point can be associated with coordinates (e.g., x, y, z in a Cartesian coordinate system) corresponding to the position of the object with respect to a position of 3D range sensor 102, with respect to controller 120, and/or with respect to any other suitable reference point. Note that although position is generally described using Cartesian coordinates, this is an example, and any suitable coordinate system can be used, such as cylindrical coordinates, cylindrical coordinates, spherical coordinates, etc.

Note that sensor region 108 in FIG. 1 is shown with an arbitrary shape, and predetermined sensor region 108 can be any suitable shape. In some embodiments, 3D range sensor 102 can include an active sensor and can emit a wave(s) 106 into sensor region 108. For example, if 3D range sensor 102 includes a LiDAR sensor, 3D range sensor 102 can be configured to emit light pulses (e.g., infrared laser pulses, visible laser pulses) into sensor region 108. As another example, if 3D range sensor 102 includes a mm wave radar sensor, 3D range sensor 102 can be configured to emit RF waves with an appropriate wavelength. Additionally or alternatively, in some embodiments, 3D range sensor 102 can include a passive sensor (e.g., a stereoscopic camera), and waves 106 can be omitted.

In some embodiments, controller 120 can be local to computing device 110 and/or 3D range sensor 102. For example, controller 120 can be incorporated with computing device 110 (e.g., controller 120 can be configured as part of computing device 110 for controlling operation of tethered air system 130, controller 120 can be configured to include 3D range sensor 102). As another example, controller 120 can be connected to computing device 110 and/or 3D range sensor by a cable, a direct wireless link, etc. Additionally or alternatively, in some embodiments, 3D range sensor 102 can be located locally and/or remotely from computing device 110 and/or controller 120, and can communicate position data to computing device 110 and/or controller 120 via a communication network.

In some embodiments, controller 120 can execute at least a portion of an air system control system 122 to control one or more operations of tethered air system 130, to send instructions and/or data to tethered air system 130, to receive instructions and/or data from tethered air system 130, etc. For example, controller 120 can execute at least a portion of air system control system 122 to instruct tethered air system 130 to move in a particular direction, to move to a particular position (e.g., a particular set of x, y, z coordinates), etc. In some embodiments, controller 120 is a ground controller, and air system 130 is a flight controller.

In some embodiments, tethered air system 130 can be any suitable UAS configured to maintain a position (e.g., using one or more rotors). In some embodiments, tethered air system 130 can be mechanically, electrically, and communicatively coupled to controller 120 via a tether 132. For example, tether 132 can include one or more electrical conductors that can be used to provide electrical power to tethered air system 130. As another example, tether 132 can include one or more electrical conductors that can be used to facilitate electrical communications between tethered air system 130 and controller 120. As yet another example, tether 132 can include one or more optical waveguides (e.g. optical fibers) that can be used to facilitate optical communications between tethered air system 130 and controller 120. As still another example, tether 132 can include one or more structural elements configured to strengthen tether 132 and/or protect components of tether 132 from the environment. In some embodiments, a wireless communication link can be used in addition to, or in lieu of, tether 132 (which in some embodiments can be omitted), and information can be communicated between air system 130 and controller 120 via the wireless communication link and/or tether 132.

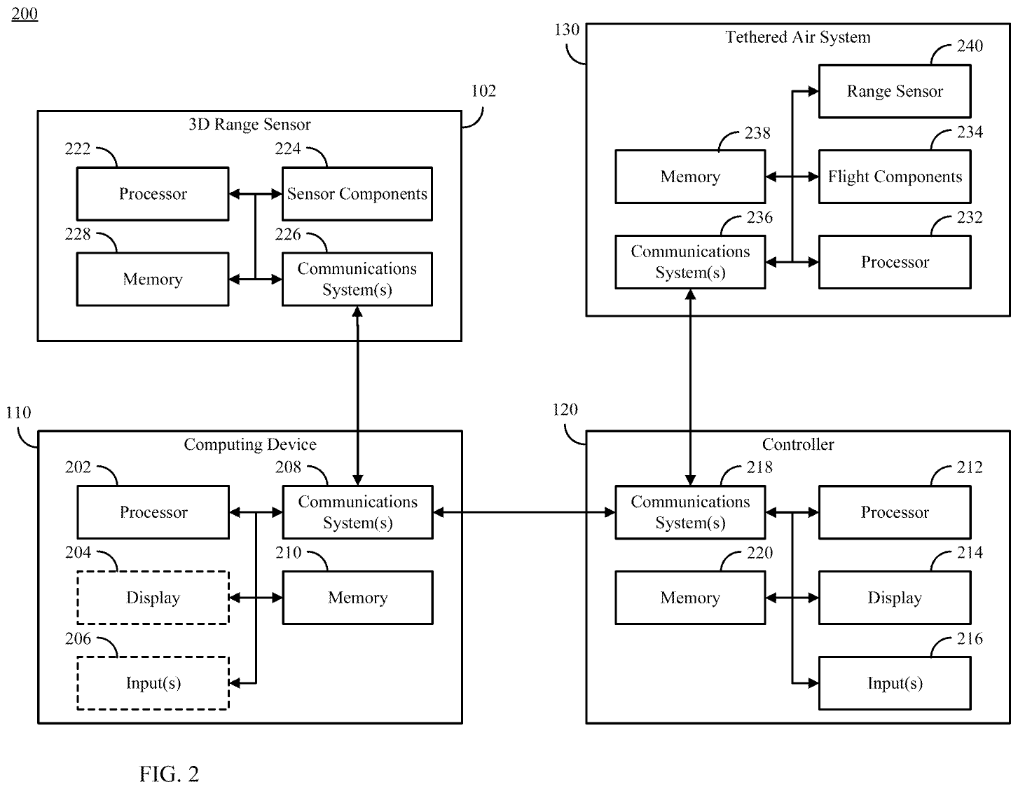

FIG. 2 shows an example of hardware that can be used to implement three-dimensional range sensor 102, computing device 110, aerial device controller 120, and aerial system 130, shown in FIG. 1 in accordance with some embodiments of the disclosed subject matter. As shown in FIG. 2, in some embodiments, computing device 110 can include a processor 202, a display 204, one or more inputs 206, one or more communication systems 208, and/or memory 210. In some embodiments, processor 202 can be any suitable hardware processor or combination of processors, such as a central processing unit (CPU), a graphics processing unit (GPU), an application specific integrated circuit (ASIC), a field-programmable gate array (FPGA), etc. In some embodiments, display 204 can include any suitable display devices, such as a computer monitor, a touchscreen, a television, etc. In some embodiments, inputs 206 can include any suitable input devices and/or sensors that can be used to receive user input, such as a keyboard, a mouse, a touchscreen, a microphone, etc. In some embodiments, display 204 and/or user inputs of inputs 206 can be omitted (e.g., when user interaction with computing device 110 is not necessary). For example, if computing device 110 is implemented as a separate device from controller 120, direct user interaction with computing device 110 may not be necessary.

In some embodiments, communications systems 208 can include any suitable hardware, firmware, and/or software for communicating information over a communication link (e.g., a wired electrical communication link, a fiber optic communication link, a wireless communication link, etc.). For example, communications systems 208 can include one or more transceivers, one or more communication chips and/or chip sets, etc. In a more particular example, communications systems 208 can include hardware, firmware and/or software that can be used to establish a Wi-Fi connection, a Bluetooth connection, a cellular connection, an Ethernet connection, etc.

In some embodiments, memory 210 can include any suitable storage device or devices that can be used to store instructions, values, etc., that can be used, for example, by processor 202 to present content using display 204, to communicate with server 120 via communications system(s) 208, etc. Memory 210 can include any suitable volatile memory, non-volatile memory, storage, or any suitable combination thereof. For example, memory 210 can include RAM, ROM, EEPROM, one or more flash drives, one or more hard disks, one or more solid state drives, one or more optical drives, etc. In some embodiments, memory 210 can have encoded thereon a computer program for controlling operation of computing device 110. In such embodiments, processor 202 can execute at least a portion of the computer program to receive position data from a 3D range sensor (e.g., 3D range sensor 102), receive altitude data from a UAS (e.g., directly, or via a controller, such as controller 120) filter position data received from a 3D range sensor, determine a position of a UAS, etc.

In some embodiments, controller 120 can include a processor 212, a display 214, one or more inputs 216, one or more communications systems 218, and/or memory 220. In some embodiments, processor 212 can be any suitable hardware processor or combination of processors, such as a CPU, a GPU, an ASIC, an FPGA, etc. In some embodiments, display 214 can include any suitable display devices, such as a computer monitor, a touchscreen, a television, etc. In some embodiments, inputs 216 can include any suitable input devices and/or sensors that can be used to receive user input, such as a keyboard, a mouse, a touchscreen, a microphone, etc.

In some embodiments, communications systems 218 can include any suitable hardware, firmware, and/or software for communicating information over a communication link (e.g., a wired electrical communication link, a fiber optic communication link, a wireless communication link, etc.). For example, communications systems 208 can include one or more transceivers, one or more communication chips and/or chip sets, etc. In a more particular example, communications systems 218 can include hardware, firmware and/or software that can be used to establish a Wi-Fi connection, a Bluetooth connection, a cellular connection, an Ethernet connection, etc.

In some embodiments, memory 220 can include any suitable storage device or devices that can be used to store instructions, values, etc., that can be used, for example, by processor 212 to present content using display 214, to communicate with one or more computing devices 110, to communicate with one or more tethered air systems 130, etc. Memory 220 can include any suitable volatile memory, non-volatile memory, storage, or any suitable combination thereof. For example, memory 220 can include RAM, ROM, EEPROM, one or more flash drives, one or more hard disks, one or more solid state drives, one or more optical drives, etc. In some embodiments, memory 220 can have encoded thereon a program for controlling operation of controller 120. In such embodiments, processor 212 can execute at least a portion of the program to transmit/receive instructions and/or information to/from one or more tethered air systems, to transmit/receive information to/from one or more computing devices 110, receive instructions from one or more devices (e.g., a personal computer, a laptop computer, a tablet computer, a smartphone, etc.), etc.

In some embodiments, 3D range sensor 102 can include a processor 222, sensor components 224, one or more communications systems 226, and/or memory 228. In some embodiments, processor 222 can be any suitable hardware processor or combination of processors, such as a CPU, a GPU, an ASIC, an FPGA, etc. In some embodiments, sensor components 224 can include any suitable components to generate 3D position data of objects within sensor region 108 (e.g., one or more lasers, optics, optical sensors, one or more antennas, etc.). Note that, although not shown, 3D range sensor 102 can include any suitable inputs and/or outputs.

In some embodiments, communications systems 226 can include any suitable hardware, firmware, and/or software for communicating information to computing device 110 and/or controller 120. For example, communications systems 226 can include one or more transceivers, one or more communication chips and/or chip sets, etc. In a more particular example, communications systems 226 can include hardware, firmware and/or software that can be used to establish a wired connection using any suitable port and/or communication standard (e.g., Ethernet, USB, RS-232, etc.), and/or any suitable wireless communication standard (e.g., Wi-Fi connection, a Bluetooth connection, a cellular connection, etc.)

In some embodiments, memory 228 can include any suitable storage device or devices that can be used to store instructions, values, position data (e.g., point cloud data), etc., that can be used, for example, by processor 222 to: control sensor components 224, and/or receive position data from sensor components 224; generate position data of objects within a sensor region (e.g., sensor region 108); and provide position data to a computing device (e.g., computing device 110, controller 120). Memory 228 can include any suitable volatile memory, non-volatile memory, storage, or any suitable combination thereof. For example, memory 228 can include RAM, ROM, EEPROM, one or more flash drives, one or more hard disks, one or more solid state drives, one or more optical drives, etc. In some embodiments, memory 228 can have encoded thereon a program for controlling operation of 3D range sensor 102. In such embodiments, processor 222 can execute at least a portion of the program to generate position data of objects with in a sensor region, transmit position information (e.g., point cloud data) to one or more computing devices 110 and/or controller 120, receive information and/or instructions from one or more computing devices 110, receive information and/or instructions from one or more controllers 120, receive instructions from one or more devices (e.g., a personal computer, a laptop computer, a tablet computer, a smartphone, etc.), etc.

In some embodiments, tethered air system 130 can include a processor 232, flight components 234, one or more communications systems 236, memory 238, and/or one or more range sensors 240. In some embodiments, processor 232 can be any suitable hardware processor or combination of processors, such as a CPU, a GPU, an ASIC, an FPGA, etc. In some embodiments, flight components 234 can include any suitable components to facilitate movement of tethered air system 130 through space (e.g., one or more rotors, one or more electric motors, one or more acceleration sensors, etc.).

In some embodiments, communications systems 236 can include any suitable hardware, firmware, and/or software for communicating information to controller 120 and/or one or more computing devices 110. For example, communications 236 can include one or more transceivers, one or more communication chips and/or chip sets, etc. In a more particular example, communications systems 236 can include hardware, firmware and/or software that can be used to establish a wired connection using any suitable port and/or communication standard (e.g., Ethernet, USB, RS-232, etc.), and/or any suitable wireless communication standard (e.g., Wi-Fi connection, a Bluetooth connection, a cellular connection, etc.)

In some embodiments, memory 238 can include any suitable storage device or devices that can be used to store instructions, values, position data (e.g., point cloud data), etc., that can be used, for example, by processor 232 to: control flight components 234; receive position data from range sensor(s) 240; generate altitude values; and provide data to a computing device (e.g., controller 120, computing device 110). Memory 238 can include any suitable volatile memory, non-volatile memory, storage, or any suitable combination thereof. For example, memory 238 can include RAM, ROM, EEPROM, one or more flash drives, one or more hard disks, one or more solid state drives, one or more optical drives, etc. In some embodiments, memory 238 can have encoded thereon a program for controlling operation of tethered air system 130. In such embodiments, processor 232 can execute at least a portion of the program to control flight components 234, transmit altitude information, other information about a status of tethered air system 130, and/or content (e.g., images from a camera (not shown), data received by tethered air system 130 from a remote source) to one or more controllers 120 and/or computing devices 110, receive information and/or instructions from one or more controllers 120, receive information and/or instructions from one or more computing devices 110, receive instructions from one or more devices (e.g., a personal computer, a laptop computer, a tablet computer, a smartphone, etc.), etc.

In some embodiments, range sensor 240 can include any suitable devices configured to determine an altitude of tethered air system 130. For example, range sensor 240 can include a laser rangefinder. As another example, range sensor 240 can include one or more GPS sensors. In some embodiments, range sensor 240 can be used to determine an altitude (e.g., relative to the ground, relative to sea level, etc.).

FIG. 3 shows an example 300 of a flow for determining a position of an aerial system in accordance with some embodiments of the disclosed subject matter. At 302, 3D range sensor 102 can detect a position of one or more objects within at least a predetermined sensor region (e.g., sensor region 108) that is expected to include a tethered air system (e.g., tethered air system 130). As described above, 3D range sensor 102 can use any suitable sensors and/or techniques to determine a position of one or more objects.

In some embodiments, the predetermined sensor region can be smaller than the total region that can in which objects can be detected by 3D range sensor 102. For example, 3D range sensor 102 can be operated over a smaller region. As another example, data points corresponding to positions outside the predetermined sensor region can be excluded from position data to be provided to another device.

In some embodiments, the boundaries of the predetermined sensor region can be determined based on instructions received from another device (e.g., computing device 110, controller 120) and/or via an input of 3D range sensor 102. For example, a user can provide instructions (e.g., via an input of 3D range sensor 102, via computing device 110, via controller 120, and/or via any other suitable computing device) designating boundaries of the predetermined senor region. As another example, position data generated by 3D range sensor 102 can be used to determine a region in which the tethered air system is most likely located (e.g., via one or more clustering techniques).

In some embodiments, 3D range sensor 102 can generate point cloud data based on detected positions of objects in the predetermined sensor region.

At 304, 3D range sensor 102 can provide position information indicative of the positions of objects at least in the predetermined senor region to computing 110 and/or controller 120. In some embodiments, 3D range sensor 102 can provide the information using any suitable technique or combination of techniques. For example, 3D range sensor 102 can provide the position information via UDP packets.

At 306, tethered air system 130 can determine an altitude of tethered air system 130 using any suitable technique or combination of techniques. For example, tethered air system 130 can use a laser range finder to determine a current altitude above ground (e.g., a AGL value). As another example, tethered air system 130 can use a barometer to determine whether a relative change in altitude has occurred. In such an example, a reference pressure (e.g., indicating a pressure at ground level, indicating a pressure associated with a known altitude above ground, etc.) can be updated periodically (e.g., at regular and/or irregular intervals) based on a known altitude determined using information from 3D range sensor 102.

At 308, tethered air system 130 can provide altitude information indicative of the altitude above ground of tethered air system 130 to computing 110 and/or controller 120 (not shown). In some embodiments, tethered air system 130 can provide the information using any suitable technique or combination of techniques. For example, tethered air system 130 can provide the altitude information via one or more UDP packets. In some embodiments, tethered air system 130 can provide additional information, such as measured accelerations (e.g., from an accelerometer).

In some embodiments, controller 120 can receive altitude information from tethered air system 130 using any suitable technique or combination of techniques.

At 310, controller 120 provide timestamped altitude information to computing device 110 using any suitable technique or combination of techniques. For example, controller 120 can provide the timestamped altitude information via one or more UDP packets. In some embodiments, controller 120 can generate a timestamp (e.g., using an internal chronometer) when altitude information is received from tethered air system 130. Additionally or alternatively, altitude information received from tethered air system 130 can be timestamped (e.g., by tethered air system 130) and/or otherwise associated with information indicative of a time when the altitude information was generated (e.g., measured) and/or transmitted. In some embodiments, controller 120 can provide the information using any suitable technique or combination of techniques. For example, controller 120 can provide the timestamped altitude information via one or more UDP packets.

In some embodiments, computing device 110 can receive altitude information transmitted by controller 120 at 310 and/or position information transmitted from 3D range sensor 102 at 304. In some embodiments, computing device 110 can determine whether there is a temporal association between an altitude value provided at 310 and position information provided at 304. For example, computing device 110 can associate altitude values and position values that having matching times (e.g., values that are synchronous, values that are within a threshold time of each other, etc.).

At 312, computing device 110 can determine a reliability of received location information using any suitable technique or combination of techniques. For example, computing device 110 can determine whether there is missing position data (e.g., from 3D range sensor 102 and/or altitude values from tethered air system 130) within a predetermined period of time preceding a current time (e.g., within about 200 milliseconds, within about 500 milliseconds, within 1 second, within 2 seconds, etc.). In a more particular example, computing device 110 can determine whether there is missing position data that was expected to be received over a predetermined period of time. In such an example, if there is missing data from tethered air system 130 and/or 3D range sensor 102, computing device 110 can determine that the position information is not reliable. In some embodiments, if computing device 110 determines that the position information is not reliable, the position data can be considered invalid. There are various potential causes of missing data, which may occur at tethered air system 130, controller 120, computing device 110, and/or 3D range sensor 102. For example, a communication link may become temporarily lost. As another example, 3D range sensor 102 may become obstructed. As yet another example, communications over one or more network links may be delayed due to a communication bottleneck. As still another example, data can be temporarily corrupted.

In some embodiments, data can be missing if no data is received from a data source (e.g., 3D range sensor 102, tethered air system 130, controller 120, etc.) within an expected period of time. Additionally or alternatively, data can be missing if available information indicates that there has been a change in altitude (e.g., based on an altitude received from tethered air system 130, based on acceleration data received from tethered air system 130). In some embodiments, if there is no change in altitude indicated, a most recent altitude determined using information from 3D range sensor 102 can be used as a current altitude. Alternatively, if there is no change in altitude indicated, the new altitude can be compared to an expected value (e.g., determined based on accelerometer data), and if the new altitude is not within a predetermined range of the expected value, altitude data can be considered missing.

As another example, computing device 110 can determine whether a connection has been dropped between computing device 110 and another device (e.g., 3D range sensor 102, controller 120, tethered air system 130). In such an example, if there is a dropped connection, computing device 110 can determine that the position information is not reliable.

As yet another example, computing device 110 can determine whether altitude values (e.g., received over the predetermined period of time) generated by the tethered air system 130 are reasonable. In such an example, computing device 110 can determine that the altitude values are reasonable if the altitude values are within a predetermined margin of an initial altitude and/or a previously determined altitude (e.g., based on reliable data). Such a predetermined margin can be determined based on acceleration information (e.g., determined based on measurements from an accelerometer of tethered air system 130). In such an example, if the altitude information is unreasonable, computing device 110 can determine that the position information is not reliable. In a more particular example, if received accelerometer information indicates that there has been no change in altitude while an altitude reported by tethered air system 130 indicates a change in altitude (e.g., based on a laser rangefinder measurement), computing device 110 can determine that the altitude is unreasonable. As another more particular example, if a change in altitude between two measurements is greater than a margin (e.g., based on a maximum speed of the tethered air system 130 and a time between the measurements), computing device 110 can determine that the altitude is unreasonable.

As still another example, computing device 110 can determine whether altitude values (e.g., received over the predetermined period of time) generated by the tethered air system 130 are associated with a position value received from 3D range sensor 102. In such an example, computing device can determine whether each altitude value is associated (e.g., within a predetermined distance of) with a Z value in corresponding position information generated by a 3D range sensor (e.g., 3D range sensor 102). In such an example, if the altitude information is not associated with a value in the position information received from the 3D range sensor, computing device 110 can determine that the position information is not reliable.

In some embodiments, 312 can be omitted. For example, the received location information may be assumed to be reliable. As another example, the reliability of the received location information can be determined periodically and may be otherwise omitted.

At 314, computing device 110 can filter position information received from 3D range sensor 102 using an altitude value measured by tethered air system 130. In some embodiments, computing device 110 can filter position information received from 3D range sensor 102 using any suitable technique or combination of techniques. For example, computing device 110 can identify points within the position information with a Z value that corresponds to the altitude measured by tethered air system 130. In such an example, computing device 110 can determine that a point within the position information has a Z value corresponding to the altitude if the Z value is within a predetermined range of the altitude value (e.g., within half a width of the tethered air system of the altitude value). In a more particular example, if tethered air system 130 is about 60 cm wide, computing device 110 can determine that a point within the position information has a Z value corresponding to the altitude if the Z value is within about 30 cm of the altitude value. As another more particular example, if tethered air system 130 is about 1.8 meters wide, computing device 110 can determine that a point within the position information has a Z value corresponding to the altitude if the Z value is within about 90 cm of the altitude value.

In some embodiments, position values that do not correspond to the altitude measured by tethered air system 130 can be disregarded and/or discarded.

At, 316, computing device 110 can determine a position of tethered air system 130 using the position information using the filtered position information. For example, using the filtered data points, computing device 110 can determine a position of the air system using the remaining points. In some embodiments, if there are multiple points (e.g., in a cluster), computing device 110 can determine a position based on an average of the points (e.g., based on an average value along each axis). Additionally or alternatively, in some embodiments, if there are multiple points (e.g., in a cluster), computing device 110 can draw a 3D bounding box that include points in the cluster, and can determine a position based on a position at the center of the bounding box. In some embodiments, computing device 110 can use any suitable technique or combination of techniques to cluster data points.

In some embodiments, computing device 110 can determine a stability of the lateral position of tethered air system 130 determined at 316. For example, computing device 110 can compare a current lateral position (e.g., X and Y position in coordinates associated with system 100, latitude and longitude, etc.) to previously determined lateral positions. If computing device 110 determines that there has been a change in current lateral position without supporting data (e.g., accelerometer data), computing device 110 can determine that the position is stable with a potential anomaly (e.g., if the anomaly has persisted for less than a threshold amount of time, such as 2 seconds), or computing device 110 can determine that the position is not stable (e.g., if an anomaly has persisted for at least a threshold amount of time). In some embodiments, if computing device 110 determines that the lateral position is unstable, computing device 110 can determine that the information is unreliable (e.g., as described above in connection with 312).

At 318, computing device 110 can provide information indicative of a position of tethered air system 130 to controller 120. In some embodiments, the information indicative of a position of tethered air system 130 can include a position of tethered air system 130 determined at 316, such as coordinates (e.g., X, Y, and Z values), latitude, longitude, altitude, etc. Additionally, in some embodiments, the information indicative of a position of tethered air system 130 can include information indicative of reliability of the position information (e.g., determined at 312).

In some embodiments, computing device 110 can provide the information using any suitable technique or combination of techniques. For example, computing device 110 can provide the information indicative of position of tethered air system 130 via one or more UDP packets. In some embodiments, controller 120 can receive position information transmitted by computing device 110 at 318.

At 320, controller 120 can generate instructions to cause tethered air system 130 to reposition based on the received information indicative of position. For example, controller 120 can generate instructions that cause tethered air system 130 to move a particular distance and/or in a particular direction, such that tethered air system 130 is caused to move to a position that is to be maintained. In some embodiments, 320 can be omitted, for example, when tethered air system 130 can autonomously (or semi-autonomously) move based on a current location and a position to be maintained.

At 322, controller 120 can provide a current position (e.g., X and Y coordinates; X, Y, and Z coordinates; latitude and longitude; latitude, longitude, and altitude) and/or instructions to move in a particular direction and/or a particular amount to tethered air system 130.

In some embodiments, controller 120 can present (e.g., using a graphical user interface) an indication of whether tethered air system 130 is maintaining a position and/or whether the location information (e.g., point cloud data generated by 3D range sensor 102 and/or altitude data generated by tethered air system 130) is reliable. For example, when the position information is reliable and/or when tethered air system 130 is maintaining the correct position, controller 120 can cause a visual indication to be provided indicating that the position is locked. As another example, when the position information is not reliable and/or when tethered air system 130 is not maintaining the correct position, controller 120 can cause a visual indication to be provided indicating that the position is not locked.

In some embodiments, controller 120 can provide the information using any suitable technique or combination of techniques. For example, controller can provide the current position and/or instructions to tethered air system 130 via one or more UDP packets.

In some embodiments, tethered air system 130 can receive position information transmitted by controller 120 at 322.

At 324, tethered air system 130 can reposition based on the current position and/or instructions provided at 322. For example, tethered air system 130 can adjust the rotation speed and/or orientation of one or more rotors to case tethered air system 130 to move to the position to be maintained.

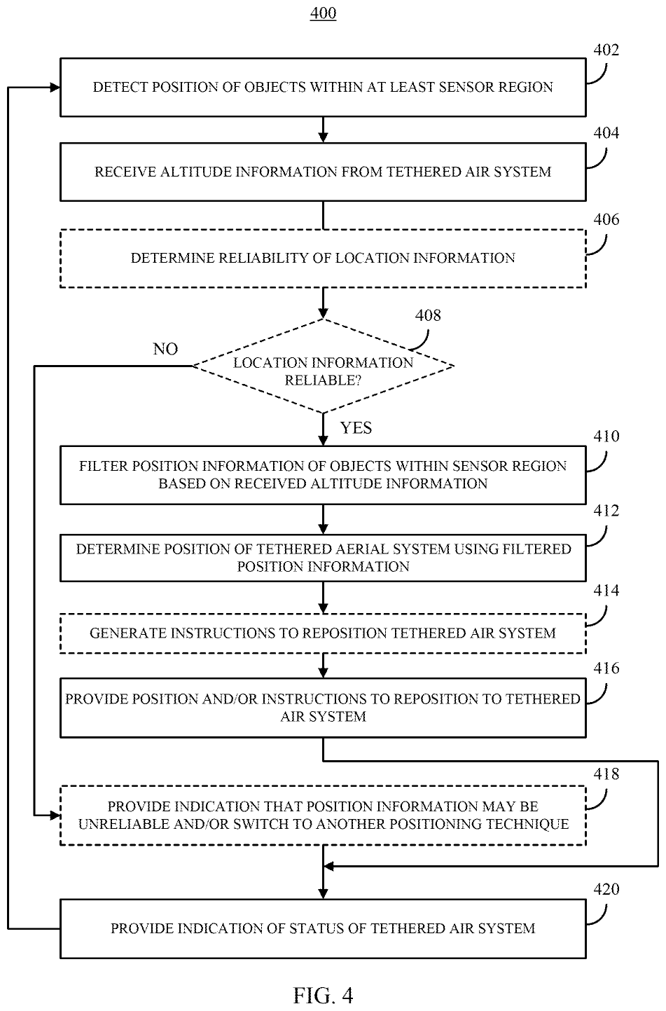

FIG. 4 shows an example of a process for determining a position of an aerial system in accordance with some embodiments of the disclosed subject matter.

As shown in FIG. 4, at 402, process 400 can detect a position of objects within at least a predetermined sensor region using any suitable technique or combination of techniques, and/or using any suitable 3D range sensor(s). For example, process 400 can detect a position of objects using one or more techniques described above (e.g., in connection with 302 of FIG. 3).

At 404, process 400 can receive altitude information from a tethered air system using any suitable technique or combination of techniques. For example, process 400 can receive altitude information using one or more techniques described above (e.g., in connection with 306 and 308 of FIG. 3).

At 406, process 400 can determine a reliability of the location information (e.g., information generated and/or received at 402 and 404) using any suitable technique or combination of techniques. For example, process 400 can determine a reliability of the location information using one or more techniques described above (e.g., in connection with 312 of FIG. 3).

At 408, if process 400 determines that the location information is not reliable (“NO” at 408), process 400 can move to 418. At 418, process 400 can provide an indication that the position information may be unreliable and/or may cause the tethered air system to switch to another position determination technique, such as GPS. For example, process 400 can cause a user interface (e.g., a graphical user interface, an indicator light, etc.) to visually indicate that the tethered air system is currently unlocked and/or that a satellite-based positioning system (e.g., GPS) is currently off. As another example, process 400 can provide an audio indication (e.g., an alarm) indicating that the position of the tethered air system has not been maintained.

In some embodiments, process 400 can receive input (e.g., user input via a graphical user interface, via a hardware switch, via a software switch, etc.) indication that determination of position and/or correction of position using location information from the 3D range sensor(s) is to be inhibited and/or that a satellite-based determination of position and/or correction of position is to be utilized.

Otherwise, if process 400 determines that the location information is reliable (“YES” at 408), process 400 can move to 410. At 410, process 400 can filter position information of objects within the sensor region (e.g., point cloud data) based on the altitude information measured by the tethered air system using any suitable technique or combination of techniques. For example, process 400 can filter the position information using one or more techniques described above (e.g., in connection with 314 of FIG. 3).

At 412, process 400 can determine a current position of the tethered air system using the filtered position information using any suitable technique or combination of techniques. For example, process 400 can determine the current position using one or more techniques described above (e.g., in connection with 316 of FIG. 3).

At 414, process 400 can generate instructions to cause the tethered air system to be repositioned from the current location to the location that the tethered air system is to be maintaining using any suitable technique or combination of techniques. For example, process 400 can generate instructions using one or more techniques described above (e.g., in connection with 320 of FIG. 3). In some embodiments, 414 can be omitted, for example when the tethered air system is configured to reposition based on current coordinates and target coordinates.

At 416, process 400 can provide current position information and/or instructions to reposition to the tethered air system 130 using any suitable technique or combination of techniques. For example, process 400 can provide current position and/or instructions using one or more techniques described above (e.g., in connection with 322 of FIG. 3).

At 420, process 400 can provide an indication of a status of tethered air system. For example, process 400 can cause a user interface (e.g., a graphical user interface, an indicator light, etc.) to visually, audibly, tactilely, etc., indicate whether the tethered air system is currently utilizing GPS positioning, or ground-based position (e.g., using position information from a 3D range sensor and altitude as described above). As another example, process 400 can cause a user interface (e.g., a graphical user interface, an indicator light, etc.) to visually, audibly, tactilely, etc., indicate whether the tethered air system is maintaining a particular position (e.g., whether it is locked or unlocked).

In some embodiments, process 400 can return to 402.

In some embodiments, any suitable computer readable media can be used for storing instructions for performing the functions and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as RAM, Flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, or any suitable media that is fleeting and devoid of any semblance of permanence during transmission, and/or any suitable intangible media.

It should be noted that, as used herein, the term mechanism can encompass hardware, software, firmware, or any suitable combination thereof.

It should be understood that the above-described steps of the processes of FIGS. 3 and 4 can be executed or performed in any order or sequence not limited to the order and sequence shown and described in the figures. Also, some of the above steps of the processes of FIGS. 3 and 4 can be executed or performed substantially simultaneously where appropriate or in parallel to reduce latency and processing times.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A method for determining a location of an air system, comprising:
receiving, from a 3D range sensor, position information indicative of a position of one or more objects in a sensor region during a first time period, wherein the position information comprises a plurality of points, each point of the plurality of points being associated with an altitude, and a 2D lateral position;
receiving, from the air system, an altitude value;
identifying one or more points of the plurality of points with an altitude corresponding to the altitude value; and
determining a current position of the air system based on the 2D lateral position associated with the one or more points.

2. The method of claim 1, wherein the 2D lateral position includes a latitude and a longitude.

3. The method of claim 1, wherein the 2D lateral position includes an X position and a Y position in a Cartesian coordinate system.

4. The method of claim 1, further comprising:
receiving, from the 3D range sensor, subsequent position information indicative of a position of one or more objects in the sensor region during a second time period;
determining that the subsequent position information is unreliable; and
in response to determining that the subsequent position information is unreliable, causing an alert to be provided.

5. The method of claim 1, further comprising:
instructing the air system to move to a target location based on the current position.

6. The method of claim 1, wherein the position information comprises point cloud data.

7. The method of claim 1, wherein the air system is a tethered air system.

8. The method of claim 1, wherein receiving the altitude value from the air system further comprises:
receiving, via a wireless link with the air system, the altitude value from the air system.

9. A system for determining a location of an air system, comprising:
at least one processor that is configured to:
receive, from a 3D range sensor, position information indicative of a position of one or more objects in a sensor region during a first time period, wherein the position information comprises a plurality of points, each point of the plurality of points being associated with an altitude, and a 2D lateral position;
receive, from the air system, an altitude value;
identify one or more points of the plurality of points with an altitude corresponding to the altitude value; and
determine a current position of the air system based on the 2D lateral position associated with the one or more points.

10. The system of claim 9, wherein the 2D lateral position includes a latitude and a longitude.

11. The system of claim 9, wherein the 2D lateral position includes an X position and a Y position in a Cartesian coordinate system.

12. The system of claim 9, wherein the at least one processor is further configured to:
receive, from the 3D range sensor, subsequent position information indicative of a position of one or more objects in the sensor region during a second time period;
determine that the subsequent position information is unreliable; and
in response to determining that the subsequent position information is unreliable, cause an alert to be provided.

13. The system of claim 9, wherein the at least one processor is further configured to:
instruct the air system to move to a target location based on the current position.

14. The system of claim 9, wherein the position information comprises point cloud data.

15. The system of claim 9, wherein the air system is a tethered air system.

16. The system of claim 9, wherein the at least one processor is further configured to:
receive, via a wireless link with the air system, the altitude value from the air system.

17. A system, comprising:
an air system comprising:
a rotor;
a motor coupled to at least one rotor;
an altitude sensor;
a communication system; and
at least one processor that is configured to:
determine an altitude value using the rangefinder; and
transmit the altitude value via the communication system;
a 3D range sensor comprising:
at least one processor that is configured to:
detect positions of objects within at least a sensor region; and
transmit information indicative of positions of objects within the sensor region;
a computing device electrically coupled to the 3D range sensor and the air system, the computing device comprising:
at least one processor that is configured to:
receive the altitude value;
receive the information indicative of positions of objects within the sensor region;
filter the information indicative of positions of objects within the sensor region using the altitude value;
determine a position of the air system based on the filtered information; and
cause the air system to move to a target position based on a difference between the determined position and the target position.

18. The system of claim 17, wherein the altitude sensor comprises a rangefinder.

19. The system of claim 17, wherein the at least one processor is further configured to:
transmit the altitude value via a tether coupled to the communication system.

20. The system of claim 17, wherein the communication system comprises a wireless transceiver, and the at least one processor is further configured to:
transmit the altitude value via the wireless transceiver.
